(19) United States
(12) Patent Application Publication
(10) Pub. No.: US 2016/0268876 A1
(43) Pub. Date: Sep. 15, 2016

(54) ELECTRIC MOTOR

(71) Applicant: MITSUBISHI ELECTRIC CORPORATION, Tokyo (JP)

(72) Inventor: Takashi Goto, Tokyo (JP)

(73) Assignee: MITSUBISHI ELECTRIC CORPORATION, Tokyo (JP)

(21) Appl. No.: 14/902,301

(22) PCT Filed: Aug. 26, 2013
(86) PCT No.: PCT/JP2013/072714

§ 371 Date: Dec. 30, 2015

(51) Int. Cl. H02K 11/215; H02K 3/04

(52) U.S. Cl. CPC H02K 11/215; H02K 3/04

(57) ABSTRACT

An electric motor 1 includes: a shaft 3 formed of a magnetic member; a rotor 5 and a sensor target 21 that rotate integrally with the shaft 3; stators 7, 8 with an armature winding 6 and by its energization, generating a rotating magnetic field; a field magnet 9 sandwiched by the stators 7, 8 to magnetize the rotor 5; and a rotation sensor 20 placed in the side of the stators 7, 8 to determine a rotational position of the shaft 3. The rotation sensor 20 incorporates a sensor magnet that generates a magnetic field passing across a sensor target 21 and a sensor element that detects a magnetic flux of the sensor magnet that varies according to a rotational position of the sensor target 21, and is placed so that the magnetic flux direction of the sensor magnet is the same as that of the field magnet 9.

### TECHNICAL FIELD

The present invention relates to an electric motor that is used such that a rotor is magnetized by a field magnet arranged on a stator.

### BACKGROUND ART

A conventional electric motor (see, for example, Patent Document 1) comprises: a rotor comprising two stacked magnetic members on which their respective projection poles serving as N-poles and S-poles are formed in a mutually twisted relation by half pitch; a stator comprising a magnetic member on which projection-pole-shape teeth are formed that are wound with an armature winding; and a field magnet arranged on the stator, to thereby rotate the rotor using interaction between a magnetic field generated in the rotor by the field magnet and a rotating magnetic field generated in the teeth of the stator by switching the current flow in the armature winding.

In such an electric motor, in order to control rotation of its rotating shaft (hereinafter, referred to as a shaft) that rotates in a unified manner with the rotor, it is required to perform sensing a rotational position, a rotational speed, a rotational acceleration rate, etc. of the shaft, and such a sensing method is popular that uses a rotation sensor which detects a rotational angle of a target in a contactless manner by converting it into a magnetic-force change. As the rotation sensor, that using a Hall IC (Integrated Circuit) method in which an amount of a magnetic flux is detected, or that using an MR (Magnetoresistance) method in which a magnetic resistance is detected, is popular (see, for example, Patent Documents 2 to 5). In these methods, because the magnetic flux of a sensor magnet flowing across a sensor target placed on the shaft changes periodically due to the rotation of the shaft, the change of the magnetic flux is detected by a sensor element to thereby determine the rotational position, etc.

### CITATION LIST

### Patent Document

Patent Document 1: Japanese Patent Application Laid-open No. H08-214519
Patent Document 2: Japanese Patent Application Laid-open No. H08-338850
Patent Document 3: Japanese Patent Application Laid-open No. 2006-12504
Patent Document 4: Japanese Patent Application Laid-open No. 2001-133212
Patent Document 5: Japanese Patent Application Laid-open No. H08-105706

### SUMMARY OF THE INVENTION

### Problems to be Solved by the Invention

According to the rotation sensor using a Hall IC method or an MR method, because of the characteristic of its sensor element, it is difficult to distinguish the magnetic flux of the sensor magnet and the other external magnetic flux (for example, a magnetic field of a magnet placed on the periphery, a magnetic field generated by a wire on the periphery, and the like). Thus, there is a problem that a sensing failure occurs in the rotation sensor influenced by the external magnetic field.

This invention has been made to solve the problem as described above, and an object thereof is to prevent a sensing failure of the rotation sensor due to influence of the external magnetic field.

### Means for Solving the Problems

An electric motor of the invention comprises: a rotating shaft formed of a magnetic member; a rotor to rotate in a unified manner with the rotating shaft; a stator that is wound with an armature winding and by its energization, generates a rotating magnetic field; a field magnet that is placed with the stator to magnetize the rotor; a sensor target formed of a magnetic member to rotate in a unified manner with the rotating shaft; a sensor magnet that is placed in a side of the stator to generate a magnetic field passing across the sensor target; and a rotation sensor that is placed in the side of the stator to detect a magnetic flux of the sensor magnet that varies according to a rotational position of the sensor target, wherein a magnetic flux direction of the field magnet is the same as that of the sensor magnet.

Another electric motor of the invention comprises: a rotating shaft formed of a magnetic member; a rotor to rotate in a unified manner with the rotating shaft; a stator that is wound with an armature winding and by its energization, generates a rotating magnetic field; a field magnet that is placed with the stator to magnetize the rotor; a sensor magnet to rotate in a unified manner with the rotating shaft; and a rotation sensor that is placed in a side of the stator to detect a magnetic flux that varies according to a rotational position of the sensor magnet, wherein a magnetic flux direction of the field magnet is the same as that of the sensor magnet.

### Effect of the Invention

According to the invention, because the magnetic flux direction of the field magnet is made the same as that of the sensor magnet, a field magnetic flux that leaks from the field magnet into the rotating shaft is added to the magnetic flux of the sensor magnet, so that the density of a magnetic flux passing across the rotation sensor becomes larger. Thus, it is possible to prevent a sensing failure of the rotation sensor due to influence of the external magnetic field.

### BRIEF DESCRIPTION OF THE DRAWINGS

FIG. 1 shows a configuration of an electric motor according to Embodiment 1 of the invention, in which shown in the right side from a rotation axis direction X is a fully cross-sectional view and in the left side is a partially cross-sectional view.

FIG. 2 shows a placement condition of a rotation sensor and a sensor target shown in FIG. 1, in which shown at FIG. 2(a) is a plan view and at FIG. 2(b) is a side view.

FIG. 3 is a graph showing a characteristic of the rotation sensor used in Embodiment 1.

FIG. 4 is a graph showing an output waveform of the rotation sensor used in Embodiment 1.

FIG. 5 is a graph showing a characteristic of the rotation sensor used in Embodiment 1, by which an effect by a leakage magnetic flux passing across a shaft will be described.

FIG. 6 is a graph showing an output waveform of the rotation sensor used in Embodiment 1, by which an effect by a leakage magnetic flux passing across the shaft will be described.

FIG. 7 is a graph showing an output waveform of the rotation sensor in a case where a placement distance between the rotation sensor and the sensor target is made large.

FIG. 8 is a plan view showing a placeable region of the rotation sensor used in Embodiment 1.

FIG. 9 is diagrams showing a field magnet in a cylindrical shape used in an electric motor according to Embodiment 1, and its magnetic-flux density distribution.

FIG. 10 is diagrams showing a field magnet in a rectangular parallelepiped shape used in an electric motor according to Embodiment 1, and its magnetic-flux density distribution.

FIG. 11 is a diagram showing a modified example of the electric motor according to Embodiment 1.

FIG. 12 is a diagram showing another modified example of the electric motor according to Embodiment 1.

### MODES FOR CARRYING OUT THE INVENTION

Hereinafter, for illustrating the invention in more detail, an embodiment for carrying out the invention will be described according to the accompanying drawings.

### Embodiment 1

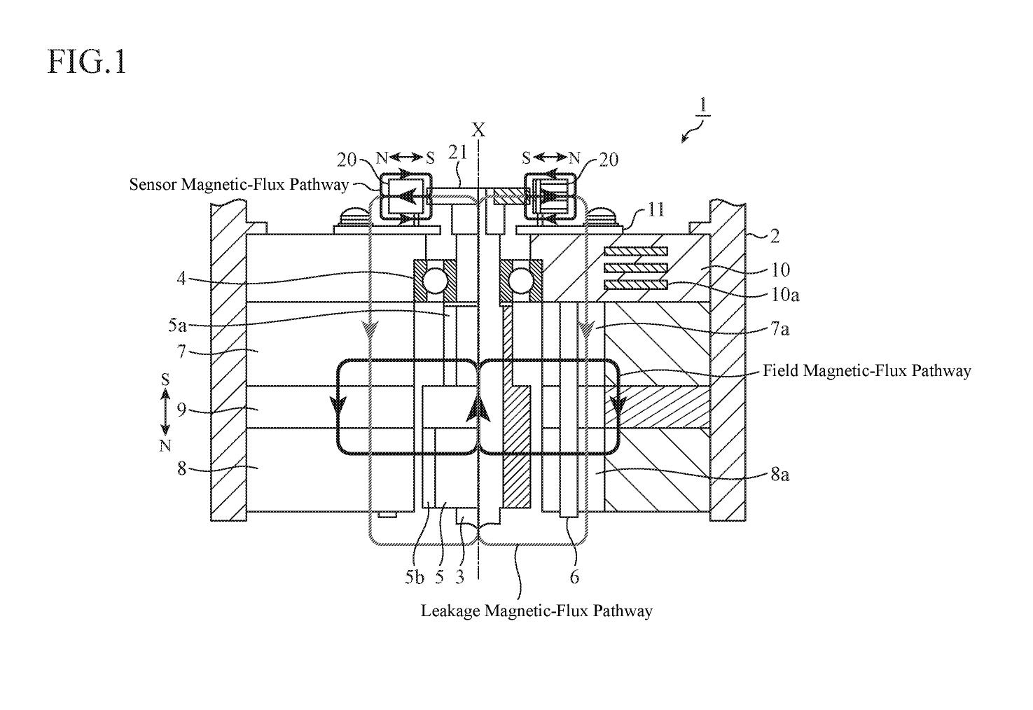

An electric motor 1 shown in FIG. 1 comprises in its housing 2 formed of a non-magnetic member: a shaft (rotating shaft) 3 formed of a magnetic member; a bearing 4 by which the shaft 3 is rotatably supported; a rotor 5 that rotates in a unified manner with the shaft 3; stators 7, 8 that are wound with an armature winding 6 and by its energization, generate a rotating magnetic field; a field magnet 9 that is placed between the stators 7, 8 to magnetize the shaft 3; rotation sensors 20 that determine a rotational position of the shaft 3; a bus bar 10 for energizing the armature winding 6; and a control board 11 that controls energization from the bus bar 10 to the armature winding 6 on the basis of the rotational position of the shaft 3.

Note that in FIG. 1, shown in the right side from a rotation axis direction X is a fully cross-sectional view and shown in the left side is a partially cross-sectional view. Further, in FIG. 1, there are placed two rotation sensors 20.

In the rotor 5 composed of a magnetic member, projection portions projecting outward are circumferentially formed at two positions 180 degrees apart from each other and each of the projection portions is placed in a state of being internally shifted by 90 degrees at a middle in the rotation axis direction X (projection portions 5a, 5b). The shaft 3 is fixed to the rotor 5, so that when the shaft 3 is rotated in a unified manner with the rotor 5, a rotative force produced at the rotor 5 is outputted outside. When the electric motor 1 is applied to an automotive turbocharger, an electric compressor and the like, the shaft 3 is joined to a rotating shaft of a turbine (so-called “impeller”), so that the turbine is rotary driven by the electric motor 1.

In the stators 7, 8 composed of magnetic members, a plurality of teeth 7a, 8a projecting inward are circumferentially formed on which the armature winding 6 is wound along the rotation axis direction X. Further, between the stators 7, 8, there is placed the field magnet 9 for magnetizing the rotor 5.

The bus bar 10 is composed of a resin member in which a copper plate coil 10a is molded integrally. One end and the other end of the coil 10a are electrically connected to the armature winding 6 and the control board 11, respectively. The control board 11 converts an unshown external power supply into an AC power supply, and causes a current to flow to the armature winding 6 while sequentially switching between the phases of the coil 10a (for example, three phases of U-phase, V-phase and W-phase) on the basis of the output of the rotation sensor 20.

The magnetic flux by the field magnet 9 magnetized in the rotation axis direction X (a field magnetic-flux pathway shown in FIG. 1) provides a field magnetic flux that flows out of the stator 8 placed in the N-pole side of the field magnet 9 into the projection portion 5b of the rotor 5, travels in the rotor 5 in the rotation axis direction X and goes out of the projection portion 5a present in the S-pole side to flow into the stator 7 placed in the S-pole side of the rotor 5. When a field magnetomotive force by the field magnet 9 acts on the rotor 5 in this manner, the projection portion 5b of the rotor 5, that is facing to the N-pole side of the field magnet 9, is magnetized to have an N-polarity, and the projection portion 5a that is facing to the S-pole side of the field magnet 9 is magnetized to have an S-polarity. When a current flowed in the armature winding 6 by way of the coil 10a of the bus bar 10, the respective teeth 7a, 8a of the stators 7, 8 are magnetized according to the direction of the flowed current to thereby generate a rotating magnetic field, so that torque is produced. When the direction of the current caused to flow in the armature winding 6 is switched under control of the control board 11, the respective NS polarities of the teeth 7a, 8a move rotationally, so that the rotor 5 rotates due to magnetomotive effect.

Next, details of the rotation sensor 20 will be described.

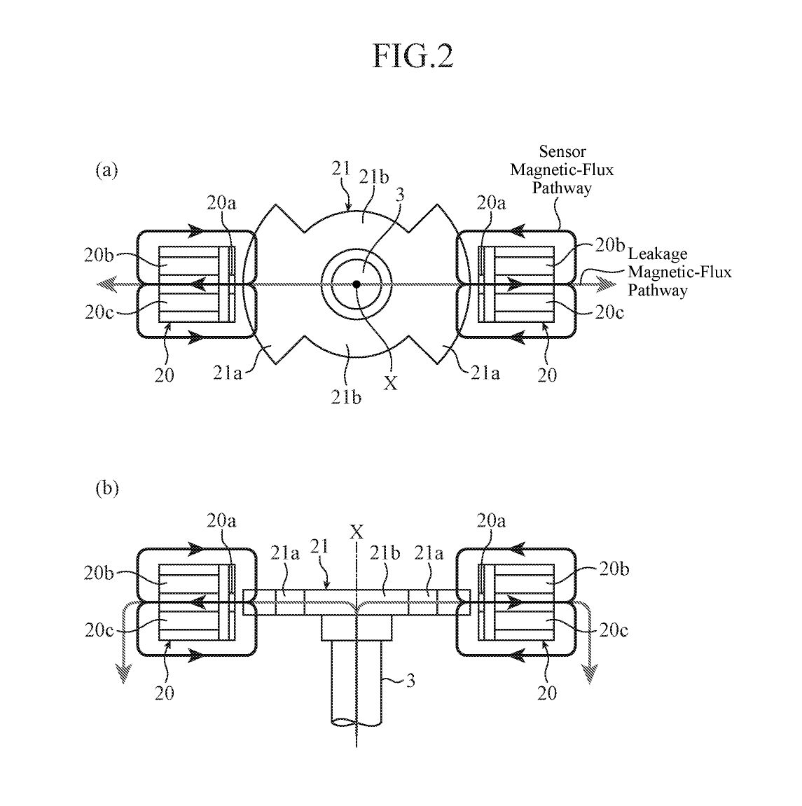

FIG. 2(a) is a plan view showing a placement condition of the rotation sensor 20 and a sensor target 21, and FIG. 2(b) is its side view. The rotation sensor 20 is an IC chip provided with a sensor element 20a and sensor magnets 20b, 20c that are integrated with each other; however, the sensor element 20a and the sensor magnets 20b, 20c may be provided separately. As the sensor element 20a, a Hall element or a magnetoresistance element is used, and in FIG. 1 and FIG. 2, the sensor element 20a is placed so that its sensing direction is perpendicular to the rotation axis direction X. The number of the sensor magnets 20b, 20c included in the rotation sensor 20 may be one or more, and the respective sensor magnets 20a, 20b are arranged so that their S-poles are directed toward the sensor target 21.

In this placement example, the magnetic fluxes of the sensor magnets 20b, 20c (sensor magnetic-flux pathways shown in FIG. 1 and FIG. 2) flow into the sensor target 21 from the N-poles of the sensor magnets 20b, 20c, and return to the S-poles of the sensor magnets 20b, 20c through the sensor element 20a.

The sensor target 21 is given as a magnetic member in a nearly-circular plate shape, and is fixed to an end portion of the shaft 3. In the sensor target 21, along the circumferential end, convex portions 21a and concave portions 21b are formed equiangularly, so that the distance between the sensor target 21 and the rotation sensor 20 is configured to vary due to the rotation of the shaft 3.

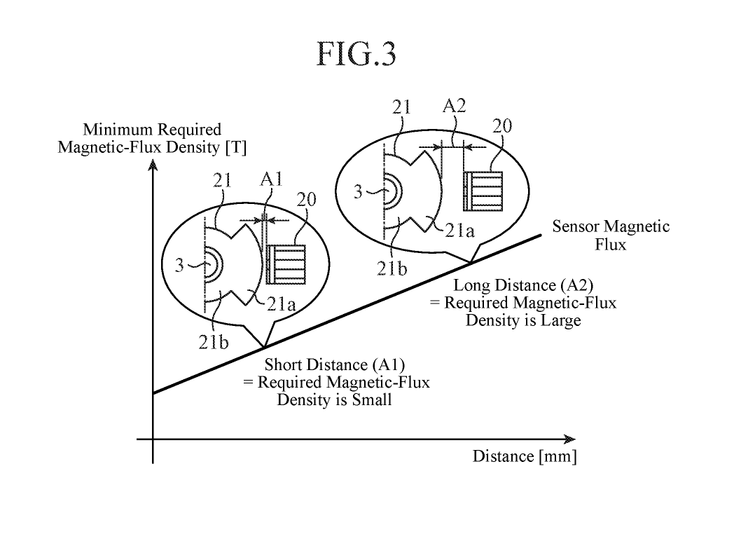

FIG. 3 is a graph showing a characteristic of the rotation sensor 20, in which the abscissa is a distance between the rotation sensor 20 and the sensor target 21 (for example, A1 or A2 in the figure), and the ordinate is a minimum magnetic-flux density that allows detection by the rotation sensor 20 (hereinafter, a minimum required magnetic-flux density). According to the graph, the nearer the distance between the rotation sensor 20 and the sensor target 21 becomes, the smaller the magnetic flux density that can be detected, and the farther the distance becomes, the larger the magnetic flux density that is required.

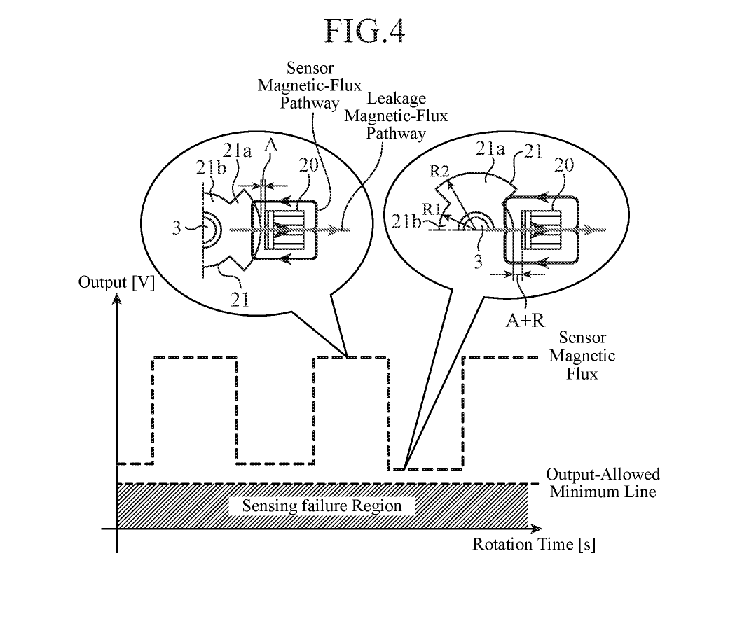

FIG. 4 is a graph showing an output waveform of the rotation sensor 20, in which the abscissa is a time during the rotation of the shaft 3 (and the sensor target 21), and the ordinate is an output voltage of the rotation sensor 20. Because the convex portion 21a and the concave portion 21b of the sensor target 21 move rotationally due to the rotation of the shaft 3, the distance between the sensor target 21 and the rotation sensor 20 varies between A and A+R. Here, assuming that the distance to the concave portion 21b from the rotation center of the shaft 3 is R1 and the distance to the convex portion 21a therefrom is R2, there is a relation of R=R2−R1.

The rotation sensor 20 outputs a voltage according to a density of the magnetic flux passing across the sensor itself. Accordingly, as shown in the graph of FIG. 4, when the convex portion 21a of the sensor target 21 becomes close to the rotation sensor 20, the density of the magnetic flux passing across the sensor element 20a becomes larger, so that the output voltage increases, whereas when the concave portion 21b becomes close to the rotation sensor 20, the density of the magnetic flux passing across the sensor element 20a becomes smaller, so that the output voltage decreases.

Furthermore, an output-allowed minimum line indicated by a broken line corresponds to the minimum required magnetic-flux density in FIG. 3, so that when the density of the magnetic flux passing across the sensor element 20a falls below the output-allowed minimum line, this causes a sensing failure, so that it becomes difficult to distinguish between the convex portion 21a and the concave portion 21b of the sensor target 21.

Next, a flow of magnetic flux in the electric motor 1 will be described.

The field magnet 9 is sandwiched between the stators 7, 8 as shown in FIG. 1, thus providing a structure that makes better transfer of the field magnetic flux, so that there is established a field magnetic-flux pathway of: field magnet 9-stator 8-rotor 5-stator 7-field magnet 9. Note that since the housing is a non-magnetic member, it is not included in the field magnetic-flux pathway.

Further, a field magnetic flux of the field magnet 9 leaks to the shaft 3 formed of a magnetic member, so that there is established a leakage magnetic-flux pathway of: field magnet 9-stator 8-rotor 5-shaft 3-sensor target 21-rotation sensor 20-stator 7-field magnet 9.

Meanwhile, because of the sensor magnets 20b, 20c of the rotation sensor 20, there are established sensor magnetic-flux pathways of: sensor magnets 20b, 20c-sensor target 21-sensor magnets 20b, 20c.

On this occasion, when the field magnetic-flux direction of the field magnet 9 is matched to the sensor magnetic-flux direction of the sensor magnets 20b, 20c, a field leakage magnetic flux passing across the shaft 3 is combined with the magnetic fluxes of the sensor magnets 20b, 20c, so that the density of the magnetic flux passing across the sensor element 20a becomes larger, to thereby enhance the tolerance of the rotation sensor 20 against an external magnetic field.

The external magnetic field is a magnetic field other than those of the sensor magnets 20b, 20c, and means a peripheral electronic-device noise, a line noise, a field magnetic field, and the like. In the electric motor 1, when, for example, the field leakage magnetic flux passing across the shaft 3 becomes directed in a direction opposite to the magnetic fluxes of the sensor magnets 20b, 20c (this case is not illustrated), this leakage magnetic flux serves to negate the sensor magnetic field, and thus can be an external magnetic field that causes a sensing failure.

In general, in order to prevent an external magnetic field from affecting on the rotation sensor 20, it is required to place an external magnetic-field blocking shield so that it covers the rotation sensor 20. However, placing the external magnetic-field block shield provides a possibility that the magnetic fields of the sensor magnets 20b, 20c are also intercepted so as not to flow into the sensor element 20a. This may result in a sensing failure. Further, this may result in cost increase due to an increased number of components, and product volume increase due to a space for placement.

As another way, there is a method in which, upon predicting an external magnetic field, the rotation sensor 20 is arranged at a position where it is, as much as possible, not affected by the external magnetic field. When the leakage magnetic flux passing across the shaft 3 becomes the external magnetic field that causes a sensing failure, the rotation sensor 20 and the sensor target 21 are to be made farther from the leakage magnetic-flux pathway; however, this results in increase of the product volume, thus reducing a value of the product itself. Further, assuming a product that is provided therearound with complicated wirings, such as an automotive motor, it is difficult to predict the external magnetic field.

Meanwhile, when the shaft 3 is changed to a non-magnetic member (for example, aluminum), the leakage magnetic flux passing across the shaft 3 can be reduced; however, the field magnetic-flux pathway of the field magnet 9 is diminished to thereby reduce an amount of the field magnetic flux. This may result in reduction of output power of the electric motor 1.

In contrast, according to the placement method of Embodiment 1, since the tolerance of the rotation sensor 20 against an external magnetic field is enhanced, it becomes unnecessary to take measures for protection from an external magnetic field, such as a shield and the like.

Further, according to Embodiment 1, a field leakage magnetic flux passing across the shaft 3 is caused to pass across the sensor element 20a of the rotation sensor 20, so that it becomes possible to set the sensor magnets 20b, 20c to have a lower grade magnetic-flux density, to thereby achieve cost reduction of the sensor magnets 20b, 20c. For example, it is possible to change from a neodymium magnet or a samarium-cobalt magnet to a ferrite magnet of a lower grade.

FIG. 5 is a graph showing a characteristic of the rotation sensor 20, in which the abscissa is a distance between the rotation sensor 20 and the sensor target 21, and the ordinate is a minimum required magnetic-flux density of the rotation sensor 20. When the field leakage magnetic flux passing across the shaft 3 is added to and combined with a minimum required magnetic-flux density (broken line) at the time it is only due to the magnetic fluxes of the sensor magnets 20b, 20c, the minimum required magnetic-flux density becomes larger as indicated by an actual line. Thus, the sensing range of the rotation sensor 20 is enlarged, so that it becomes possible to detect a farther sensor target 21. In other words, even if the sensor magnets 20b, 20c having a magnetic flux density that is smaller by the leakage magnetic flux are used and thus the minimum required magnetic-flux density is lowered, it becomes possible to detect the sensor target 21.

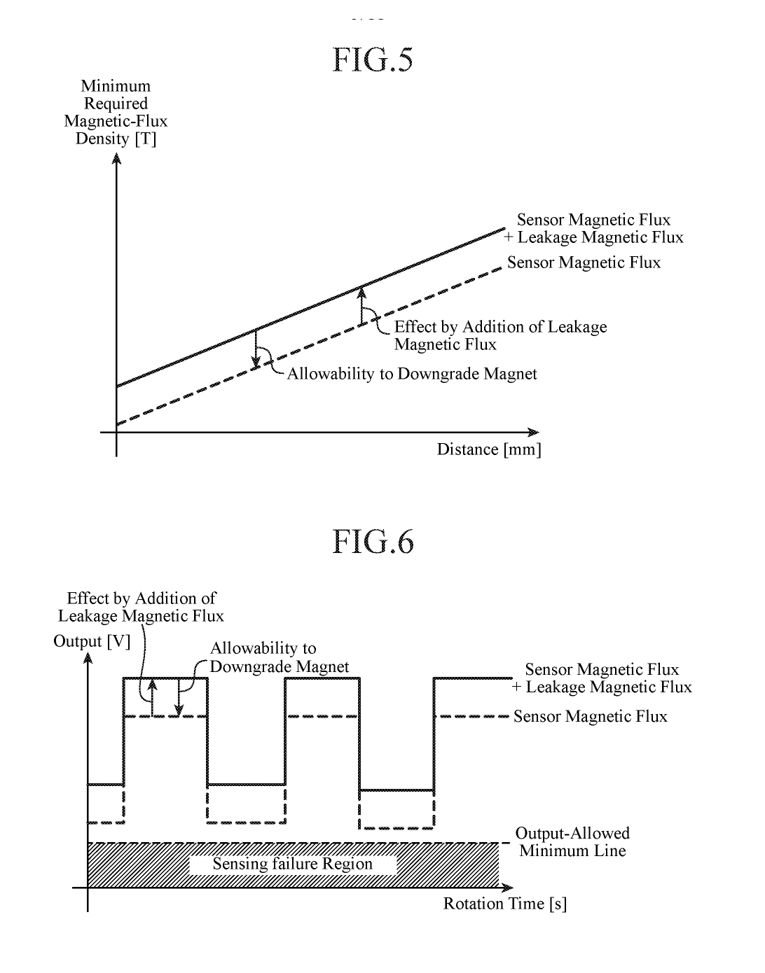

FIG. 6 is a graph showing an output waveform of the rotation sensor 20, in which the abscissa is a time during the rotation of the shaft 3, and the ordinate is an output voltage of the rotation sensor 20. As compared to an output voltage when it is only due to the magnetic fluxes of the sensor magnets 20b, 20c (broken line), the output voltage when the field leakage magnetic flux passing across the shaft 3 is added to and combined with the sensor magnetic fluxes, becomes higher (actual line). In other words, even if the sensor magnets 20b, 20c having a magnetic flux density that is smaller by the leakage magnetic flux are used, it is possible to establish the output voltage indicated by the broken line, so that a sensing failure does not arise.

Furthermore, according to Embodiment 1, it is possible to enlarge the placeable region of the rotation sensor 20 relative to the sensor target 21, to thereby enhance the flexibility for its placement.

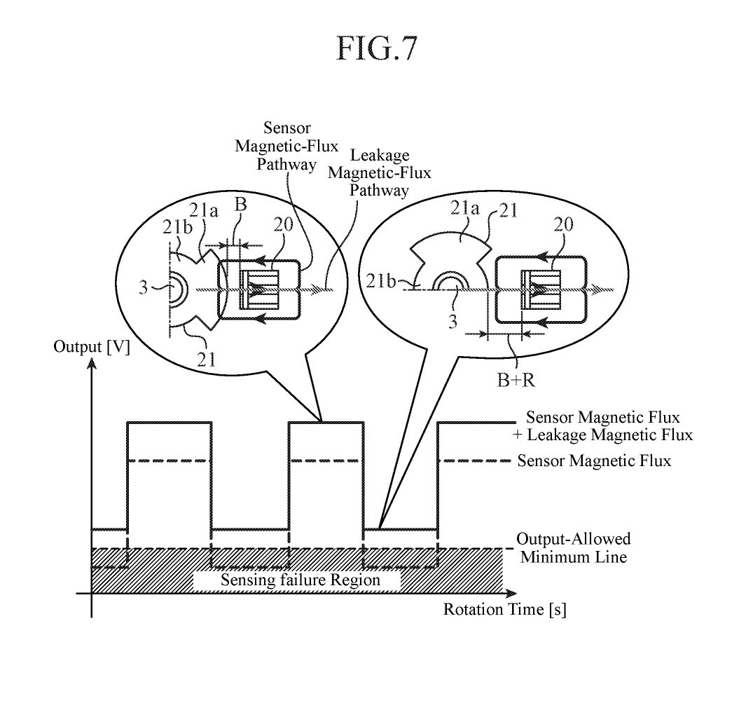

In FIG. 7, there is shown an output waveform of the rotation sensor 20 in a case where the placement distance between the rotation sensor 20 and the sensor target 21 is made large. In FIG. 7, as compared to the distances A and A+R in FIG. 4, the distances B and B+R (B>A) between the sensor target 21 and the rotation sensor 20 are made larger. The distance B+R is larger than the distance that satisfies the minimum required magnetic-flux density required for the rotation sensor 20 to detect the sensor target 21. Thus, as indicated in the graph by a broken line, only the magnetic fluxes of the sensor magnets 20b, 20c result in a sensing failure when the concave portion 21b becomes opposite to the rotation sensor 20.

In contrast, according to Embodiment 1, the field leakage magnetic flux passing across the shaft 3 is added to and combined with the magnetic fluxes of the sensor magnets 20b, 20c. Thus, as indicated in the graph of FIG. 7 by an actual line, a sensing failure does not arise even when the concave portion 21b of the sensor target 21 becomes opposite to the rotation sensor 20. Accordingly, the placement distance of the rotation sensor 20 relative to the sensor target 21 can be made larger than the distance that satisfies the minimum required magnetic-flux density required for the rotation sensor 20 to detect the sensor target 21.

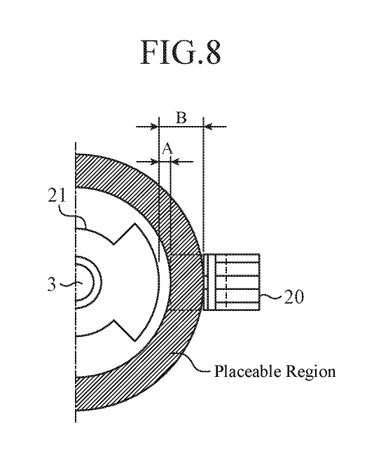

In FIG. 8, there is shown a placeable region of the rotation sensor 20. Generally, the rotation sensor 20 is placed at a position apart by the distance A from the sensor target 21, whereas according to Embodiment 1, the rotation sensor 20 can be placed at the distance B (B>A) that is farther than the distance A, so that the placeable region is enlarged.

It suffices that the distance B is determined by means of a magnetic field analysis.

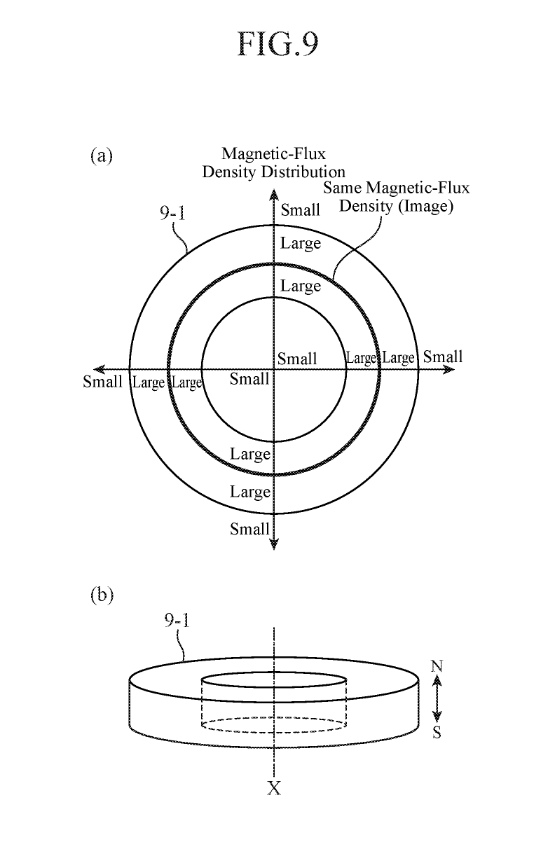

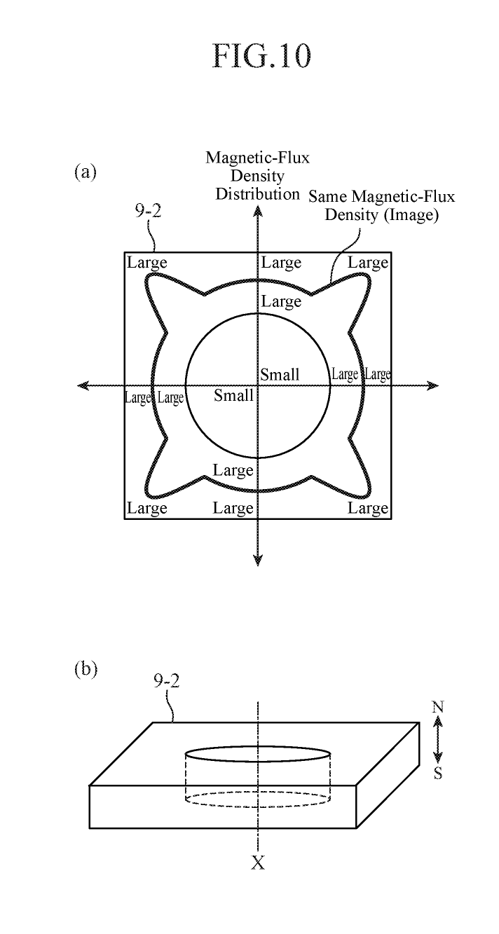

However, it should be taken into consideration that the shape of the placeable region of the rotation sensor 20 depends on the shape of the field magnet 9. In FIG. 9, there are shown a field magnet in a cylindrical shape 9-1 and its magnetic-flux density distribution, and in FIG. 10, there are shown a field magnet in a rectangular parallelepiped shape (may instead be a regular hexahedron shape or the like) 9-2 and its magnetic-flux density distribution. A place where the magnetic flux density is measured for each of the field magnets 9-1 and 9-2 is given at the position with the same height from their surfaces. In both of the field magnets 9-1 and 9-2, there are formed holes in their centers through which the shaft 3 and the rotor 5 are passed. Further, the magnetized directions of the field magnets 9-1 and 9-2 are both set to the rotation axis direction X.

As shown in FIG. 9(a) and FIG. 10(a), the magnetic flux density is large on the field magnets 9-1, 9-2, and becomes smaller outwardly or inwardly therefrom. In the case of the field magnet in a cylindrical shape 9-1 as shown in the outline perspective view of FIG. 9(b), the magnitude of the magnetic flux density is concentrically the same. Thus, when a plurality of rotation sensors 20 are placed concentrically around the shaft 3, the rotation sensors 20 can be used with the same sensor controlling value without changing their specifications. In contrast, in the case of the field magnet in a rectangular parallelepiped shape 9-2 as shown in the outline perspective view of FIG. 10(b), the magnetic flux density is not concentrically uniform and thus the magnetic flux is different depending on the position. Thus, when a plurality of rotation sensors 20 are to be placed, it is necessary to change a sensor controlling value depending on the placement position.

Consequently, according to Embodiment 1, the electric motor 1 comprises: the shaft 3 formed of a magnetic member; the rotor 5 that rotates in a unified manner with the shaft 3; the stators 7, 8 that are wound with the armature winding 6 and by its energization, generates a rotating magnetic field; the field magnet 9 that is placed with the stators 7, 8, to magnetize the rotor 5; the sensor target 21 formed of a magnetic member that rotates in a unified manner with the rotor 5; the sensor magnets 20b, 20c that are placed in a side of the stators 7, 8 to generate magnetic fields passing across the sensor target 21; and the rotation sensors 20 each placed in the side of the stators 7, 8, to detect magnetic fluxes of the sensor magnets 20b, 20c that vary according to a rotational position of the sensor target 21, wherein the magnetic flux direction of the field magnet 9 is the same as that of the sensor magnets 20b, 20c. Accordingly, the field leakage magnetic flux passing across the shaft 3 from the field magnet 9 is added to the magnetic fluxes of the sensor magnets 20b, 20c, so that the density of the magnetic flux passing across the rotation sensor 20 becomes large. Thus, it is possible to prevent a sensing failure of the rotation sensor 20 due to influence of the external magnetic field. As a result, it becomes unnecessary to take measures for protection from an external magnetic field, such as a shield and the like, thus making it possible to reduce cost and size of the electric motor 1. Further, because the density of the magnetic flux passing across the rotation sensor 20 becomes large, a sensing lower-limit value of the rotation sensor 20 is improved, so that it is possible to achieve cost reduction using the sensor magnets 20b, 20c of a reduced grade.

Further, because the sensing limit-value of the rotation sensor 20 is improved, the placement distance of the rotation sensor 20 relative to the sensor target 21 can be made larger than the distance that satisfies the minimum required magnetic-flux density required for the rotation sensor 20 to detect the sensor target 21. This enlarges the placeable region of the rotation sensor 20, to thereby enhance the flexibility for its placement.

Note that, when the magnetic flux directions of the field magnet 9 and the sensor magnets 20b, 20c are set to the same, the both magnetic flux directions are not required to be exactly matched to each other and may be in a range where the effects as described above are achieved (for example, within ±10 degrees as an angle between the both magnetic flux directions).

Further, according to Embodiment 1, when a plurality of rotation sensors 20 are to be placed, such a configuration is applied in which the plurality of rotation sensors 20 are concentrically placed around the shaft 3, and the field magnet 9 is in a cylindrical shape that surrounds the shaft 3 (for example, the field magnet 9-1 in FIG. 9). This makes it unnecessary to change the specifications of the plurality of rotation sensors 20, so that the placement becomes easier.

Further, according to Embodiment 1, the electric motor 1 is configured with the housing 2 formed of a non-magnetic member that fixes the stators 7, 8 and the field magnet 9. This prevents occurrence of a magnetic bypass that is a field magnetic-flux pathway of the field magnet 9 not passing through the rotor 5 but passing through the housing 2, thus making it possible to prevent reduction of the output power of the electric motor 1.

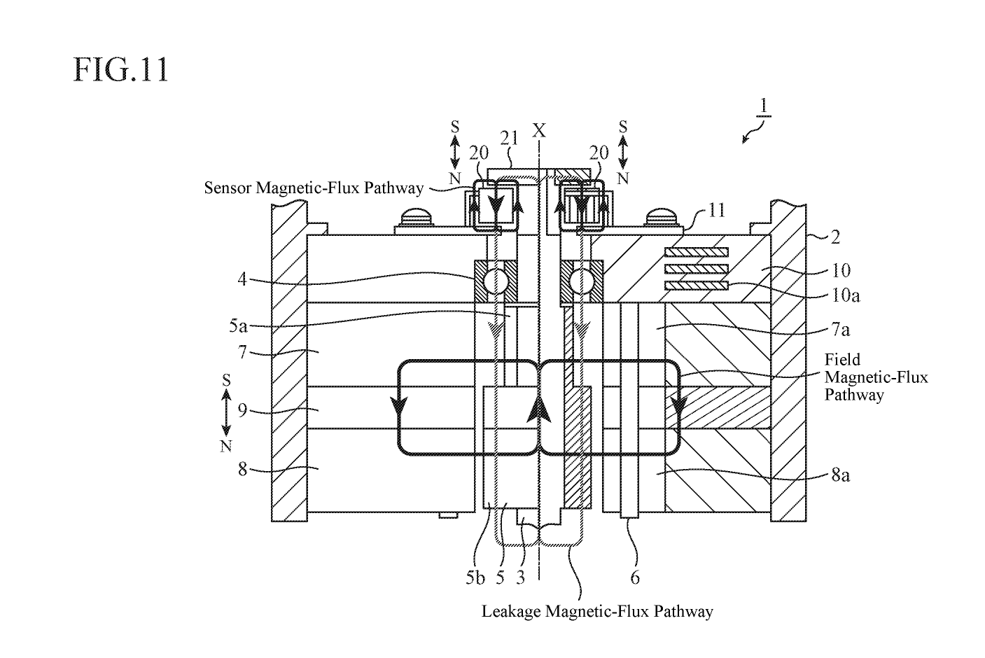

Note that, in the foregoing description, although the rotation sensor 20 is placed so that the sensing direction of the sensor element 20a is perpendicular to the rotation axis direction X as shown in FIG. 1, the rotation sensor 20 may be placed so that the sensing direction of the sensor element 20a is parallel to the rotation axis direction X as shown in FIG. 11. Even in this case, when the field magnetic-flux direction of the field magnet 9 and the sensor magnetic-flux direction of the sensor magnets 20b, 20c are matched to each other, the field leakage magnetic flux passing across the shaft 3 is combined with the magnetic fluxes of the sensor magnets 20b, 20c, so that the density of the magnetic flux passing across the sensor element 20a becomes larger.

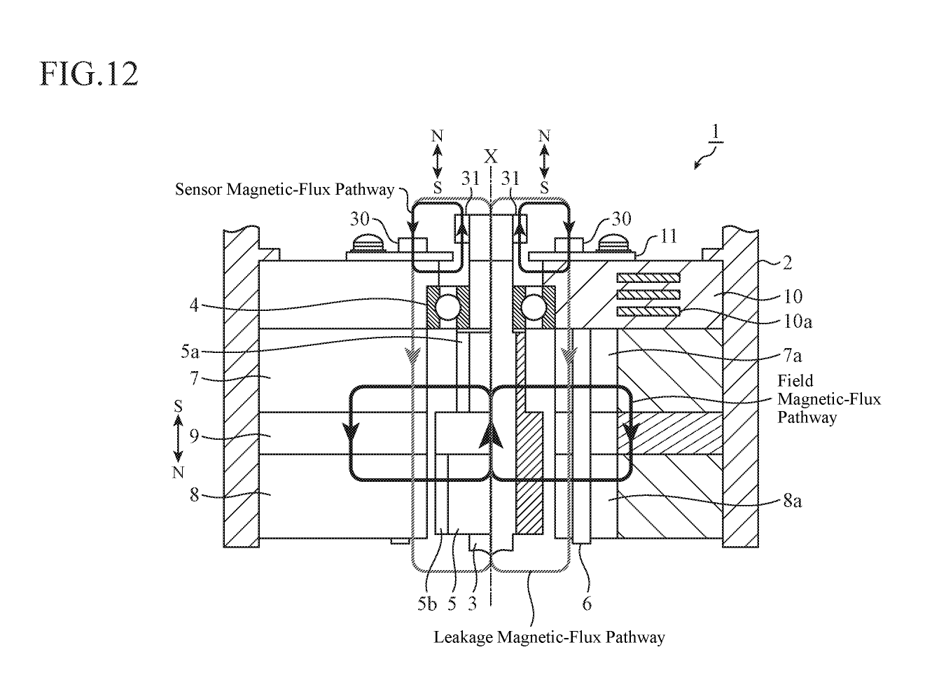

Further, in the foregoing description, the configuration as shown in FIG. 1 is applied in which the magnetic flux passing across the sensor target 21 fixed to the shaft 3 is detected by the rotation sensor 20; however, a configuration as shown in FIG. 12 may instead be applied in which the magnetic flux passing across a sensor magnet 31 fixed to the shaft 3 is detected by a rotation sensor 30. Specifically, the electric motor 1 may be configured with: the shaft 3 formed of a magnetic member; the rotor 5 that rotates in a unified manner with the shaft 3; the stators 7, 8 that are wound with the armature winding 6 and by its energization, generate a rotating magnetic field; the field magnet 9 that is placed with the stators 7, 8, to magnetize the rotor 5; the sensor magnets 31 that rotate in a unified manner with the shaft 3; and rotation sensors 30 each placed in the side of the stators 7, 8, to detect magnetic fluxes that vary according to a rotational position of the sensor magnets 31. Even in this configuration, when the field magnetic-flux direction of the field magnet 9 and the sensor magnetic-flux direction of the sensor magnet 31 are matched to each other, the field leakage magnetic flux passing across the shaft 3 is combined with the magnetic flux of the sensor magnet 31, so that the density of the magnetic flux passing across a sensor element (not shown) included in the rotation sensor 30 becomes larger.

It should be noted that, other than the above, modification of any configuration element in the embodiment and omission of any configuration element in the embodiment may be made in the present invention without departing from the scope of the invention.

### INDUSTRIAL APPLICABILITY

As described above, the electric motor according to the invention prevents a sensing failure of the rotation sensor due to the leakage magnetic flux of the field magnet in such a manner that the magnetic flux direction of the sensor magnet of the rotation sensor and the magnetic flux direction of the field magnet are matched to each other. Thus, the invention is suited to be applied to an electric motor equipped with a field magnet for magnetizing a rotor, or the like.

### DESCRIPTION OF REFERENCE NUMERALS AND SIGNS

1: electric motor, 2: housing, 3: shaft, 4: bearing, 5: rotor, 5a, 5b: projection portions, 6: armature winding, 7, 8: stators, 7a, 8a: teeth, 9, 9-1, 9-2: field magnet, 10: bus bar, 10a: coil, 11: control board, 20, 30: rotation sensor, 20a: sensor element, 20b, 20c, 31: sensor magnet, 21: sensor target, 21a: convex portion, 21b: concave portion.

1. An electric motor comprising:
a rotating shaft formed of a magnetic member;
a rotor to rotate in a unified manner with the rotating shaft;
a stator that is wound with an armature winding and by its energization, generates a rotating magnetic field;
a field magnet that is placed with the stator to magnetize the rotor;
a sensor target formed of a magnetic member to rotate in a unified manner with the rotating shaft;
a sensor magnet that is placed in a side of the stator to generate a magnetic field passing across the sensor target; and
a rotation sensor that is placed in the side of the stator to detect a magnetic flux of the sensor magnet that varies according to a rotational position of the sensor target,
wherein a magnetic flux direction of the field magnet is the same as that of the sensor magnet.

2. An electric motor comprising:
a rotating shaft formed of a magnetic member;
a rotor to rotate in a unified manner with the rotating shaft;
a stator that is wound with an armature winding and by its energization, generates a rotating magnetic field;
a field magnet that is placed with the stator to magnetize the rotor;
a sensor magnet to rotate in a unified manner with the rotating shaft; and
a rotation sensor that is placed in a side of the stator to detect a magnetic flux that varies according to a rotational position of the sensor magnet,
wherein a magnetic flux direction of the field magnet is the same as that of the sensor magnet.

3. The electric motor of claim 1, wherein a placement distance of the rotation sensor relative to the sensor target is larger than a distance that satisfies a minimum magnetic-flux density of the sensor magnet, required for the rotation sensor to detect the sensor target.

4. The electric motor of claim 2, wherein a placement distance of the rotation sensor relative to the sensor magnet is larger than a distance that satisfies a minimum magnetic-flux density, required for the rotation sensor to detect the sensor magnet.

5. The electric motor of claim 1, wherein, in the case where a plurality of rotation sensors each being said rotation sensor are placed, the plurality of rotation sensors are placed concentrically around the rotating shaft, and the field magnet is in a cylindrical shape that surrounds the rotating shaft.

6. The electric motor of claim 2, wherein, in the case where a plurality of rotation sensors each being said rotation sensor are placed, the plurality of rotation sensors are placed concentrically around the rotating shaft, and the field magnet is in a cylindrical shape that surrounds the rotating shaft.

7. The electric motor of claim 1, wherein the rotation sensor is a Hall element or a magnetoresistance element.

8. The electric motor of claim 2, wherein the rotation sensor is a Hall element or a magnetoresistance element.

9. The electric motor of claim 1, wherein the sensor target is a circular plate-like member having at its outer circumferential end, at least one concave-convex shape.

10. The electric motor of claim 1, further comprising a housing formed of a non-magnetic member by which the stator and the field magnet are fixed.

11. The electric motor of claim 2, further comprising a housing formed of a non-magnetic member by which the stator and the field magnet are fixed.
